(19) United States
(12) Patent Application Publication
(10) Pub. No.: US 2023/0282833 A1
(43) Pub. Date: Sep. 7, 2023

(54) A HYDROGEL BINDER AND A FREE-STANDING ELECTRODE

(71) Applicant: AGENCY FOR SCIENCE, TECHNOLOGY AND RESEARCH, Singapore (SG)

(72) Inventors: Jackie Y. YING, Singgapore (SG); Jian LIang CHEONG, Singgapore (SG)

(21) Appl. No.: 18/016,315

(22) PCT Filed: Jul. 14, 2021
(86) PCT No.: PCT/SG2021/050410

§ 371 Date: Jan. 13, 2023

(30) Foreign Application Priority Data
Jul. 14, 2020 (SG) 10202006704V

(51) Int. Cl. H01M 4/62; H01M 4/131; C08L 5/04; C08L 79/02

(52) U.S. Cl. CPC H01M 4/622; H01M 4/625; H01M 4/131; C08L 5/04; C08L 79/02

(57) ABSTRACT

There is provided a hydrogel binder and a method of synthesizing the same. There is also provided a free-standing electrode comprising the hydrogel binder and a method of preparing the free-standing electrode comprising the hydrogel binder. There is further provided a battery comprising the free-standing electrode as defined herein.

### REFERENCES TO RELATED APPLICATIONS

This application is a US national phase application under 35 USC § 371 of International Application No. PCT/SG2021/050410, filed Jul. 14, 2021, and claims priority to Singapore application number 10202006704V filed on 14 Jul. 2020, the disclosure of which was incorporated by reference.

### TECHNICAL FIELD

The present invention generally relates to a hydrogel binder and a method of synthesizing the same. The present invention also relates to a free-standing electrode comprising the hydrogel binder and a method of preparing the free-standing electrode. The present invention further relates to a battery comprising the free-standing electrode as defined herein.

### BACKGROUND ART

The ongoing electrification of the transport system and increasing need for grid storage solutions are driving up the demand for energy storage systems. Benefitting from technological advances and economies of scale, a rechargeable lithium-ion battery (LIB) is currently the primary choice for energy storage due to its high energy density and relatively low cost. However, LIBs may not be able to meet future energy needs for more demanding applications such as large-scale grid storage and long-mileage electric vehicles (EV). With a theoretical energy density five times higher than LIBs and an abundant cathode material, a lithium-sulfur battery (LSB) is considered to be a highly promising next-generation energy storage technology. 2D metallic current collectors form an integral part of commercial rechargeable batteries, providing mechanical support to the electrode and ensuring good electrical contact to the external circuit. However, metal current collectors are electrochemically inactive with negative impact to energy density, and susceptible to corrosion due to the F-containing salts in the electrolyte, leading to battery failure.

Conventional LIB and LSB cells consist of positive and negative electrodes that are separated by an electronically insulating layer. In LIBs, electrode fabrication involves coating anode and cathode active materials onto copper and aluminium current collectors, respectively. These metallic current collectors provide mechanical support for the active materials, and ensure good electrical connection with the external circuit. However, the electrochemically inactive metal current collectors are heavy, and therefore contribute significantly to the inactive mass of the battery system—up to ˜9.6 wt % in a Panasonic NCR18650B cell. In addition, decomposition of fluorine-based lithium hexafluorophosphate and bis(trifluoromethane)sulfonimide lithium in the battery electrolyte results in HF generation, leading to corrosion of the metal current collectors and eventually, battery failure.

Recently, there has been increasing research interest in 3D carbon-based free-standing electrodes as they offer higher energy density and are resistant to corrosion. Unlike traditional electrodes, carbon-based free-standing electrodes are superior alternatives because they are light and metal-free, leading to higher battery energy density and better cycling stability. Free-standing electrodes include graphene foams/sponges, carbon cloth/carbon fibers, carbon nanotube paper/arrays/network, an the like. While these electrodes have good electrochemical performance, their conventional preparation methods involve specialized equipment and laborious methods, such as chemical vapor deposition (CVD), hydrothermal synthesis, ultrasonication, filtration, which are costly to implement for large-scale production.

Another method of preparing free-standing electrodes includes slurry coating on a single type of electrode of either lithium cobalt oxide, lithium titanium oxide or lithium iron phosphate (LFP), which is highly limited.

Accordingly, there is a need for a method of making a free-standing electrode that ameliorates one or more disadvantages mentioned above.

### SUMMARY

In one aspect, there is provided a hydrogel binder comprising an anionic polyacid, a cationic polyamine and a solvent, wherein the anionic polyacid and the cationic polyamine are derived from an acid-base reaction between a polyacid and a polyamine at a weight ratio in the range of 10:100 to 40:100.

Advantageously, the weight ratio between the polyacid and the polyamine may result in a solid structure that allows an effective dispersion of materials, such as active electrode materials, single-wall nanotubes or conductive additives in the hydrogel binder.

In another aspect, there is provided a method of synthesizing a hydrogel binder comprising mixing a polyacid with a polyamine at a weight ratio in the range of 10:100 to 40:100 in a solvent.

In another aspect, there is provided a free-standing electrode comprising a hydrogel binder and carbon nanotubes, wherein the hydrogel binder comprises an anionic polyacid and a cationic polyamine, and wherein the anionic polyacid and the cationic polyamine are derived from an acid-base reaction between a polyacid and a polyamine at a weight ratio in the range of 10:100 to 40:100.

In another aspect, there is provided a method of preparing a free-standing electrode comprising the steps of: a) mixing a hydrogel binder and single-wall nanotubes in a mixing solvent to form a slurry, wherein the hydrogel binder comprises an anionic polyacid and a cationic polyamine, and wherein the anionic polyacid and the cationic polyamine are derived from an acid-base reaction between a polyacid and a polyamine at a weight ratio in the range of 10:100 to 40:100 and a solvent; and b) casting and drying the slurry of step (a) on a substrate to form the free-standing electrode.

In another aspect, there is provided a battery comprising the free-standing electrode as described herein, a sulfur source, a separator and an electrolyte.

In another aspect, there is provided a battery comprising at least one free-standing electrode as described herein, a separator and an electrolyte.

### Definitions

The following words and terms used herein shall have the meaning indicated:

The term “polyacid” refers to a polymer comprising at least one acidic moiety, such as a carboxylic acid group, a phosphonic acid group, a sulfonic acid group. The polymer may be derived from monomers that comprise at least one of said acidic moiety.

The term “polyamine” refers to a polymer comprising at least one amino moiety. The polymer may be derived from monomers that comprise at least one amino moiety.

The term “transition metal” refers to an element selected from Groups 3 to 12 in the Periodic Table of Elements.

The term “free-standing” when used to refer electrodes means that the electrodes may function properly by themselves. Therefore, the electrodes do not contain additional metallic current collectors.

The term “metalloid” as used in this disclosure refers to an element selected from the group consisting of boron, silicon, germanium, arsenic, antimony, tellurium, or combinations thereof.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

The term “about” as used herein typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### Detailed Disclosure of Embodiments

Exemplary, non-limiting embodiments of a hydrogel binder will now be disclosed.

The hydrogel binder may comprise an anionic polyacid and a cationic polyamine in a solvent.

The anionic polyacid and the cationic polyamine may be derived from an acid-base reaction between a polyacid and a polyamine at a weight ratio in the range of about 10:100 to about 40:100. As the polyacid is deprotonated during the acid-base reaction, it becomes the anionic polyacid in the hydrogel state. As the polyamine is protonated during the acid-base reaction, it becomes the cationic polyacid in the hydrogel state.

Advantageously, the weight ratio between the polyacid and the polyamine as defined herein results in a homogeneous hydrogel binder. The hydrogel binder may have a solid structure that allows an effective dispersion of materials, such as active electrode materials, single-wall nanotubes or conductive additives in the hydrogel binder.

In the acid-base reaction, the weight ratio between the polyacid and the polyamine may be in the range of about 25:100 to about 40:100, about 30:100 to about 40:100, about 35:100 to about 40:100, about 20:100 to about 35:100, about 10:100 to about 30:100, about 20:100 to about 40:100 or about 10:100 to about 20:100.

In the acid-base reaction, the weight ratio between the polyacid and the polyamine may be about 24:100.

In the hydrogel binder, the solvent may be an aqueous medium. In the hydrogel binder, the solvent may be water.

In the hydrogel binder, the anionic polyacid may be an anionic polycarboxylic acid or an anionic polysulfonic acid, or a combination thereof. The anionic polyacid may be anionic alginic acid, anionic hyaluronic acid, anionic polyacrylic acid, anionic polymethacrylic acid, anionic polystyrenesulfonic acid, anionic polyvinylsulfonic acid or a combination thereof. When used in the acid-base reaction, the polyacid may be a polycarboxylic acid or a polysulfonic acid, or a combination thereof. The polyacid may be alginic acid, hyaluronic acid, polyacrylic acid, polymethacrylic acid, polystyrenesulfonic acid, polyvinylsulfonic acid, a salt thereof or a combination thereof.

In the hydrogel binder, the anionic polyacid may be anionic alginic acid.

In the hydrogel binder, the cationic polyamine may be cationic polyethyleneimine, cationic chitosan, cationic polyacrylamine, or a combination thereof. When used in the acid-base reaction, the polyamine may be polyethyleneimine, chitosan, polyacrylamine, a salt thereof or a combination thereof.

In the hydrogel binder, the cationic polyamine may be cationic polyethyleneimine.

In the hydrogel binder, the anionic polyacid and the cationic polyamine may have a combined concentration in the solvent in the range of about 30 mg/mL to 125 mg/mL, 100 mg/mL to about 200 mg/mL, about 125 mg/mL to about 200 mg/mL, about 150 mg/mL to about 200 mg/mL, about 175 mg/mL to about 200 mg/mL, about 100 mg/mL to about 175 mg/mL, about 100 mg/mL to about 150 mg/mL, about 100 mg/mL to about 125 mg/mL or about 125 mg/mL to about 150 mg/mL.

In the hydrogel binder, the anionic polyacid and the cationic polyamine may have a combined concentration of about 140 mg/mL in the solvent.

The hydrogel binder may be made from, obtained from or obtainable from a method comprising mixing a polyacid and a polyamine at a weight ratio in the range of about 10:100 to about 40:100 in a solvent.

The hydrogel binder may be made according to the method as described herein.

Exemplary, non-limiting embodiments of a method of synthesizing a hydrogel binder will now be disclosed.

The method comprises mixing a polyacid and a polyamine at a weight ratio in the range of about 10:100 to about 40:100 in a solvent. In the mixing step, the polyacid and the polyamine may react with each other in an acid-base reaction, such that the polyacid becomes deprotonated (thus being anionic), and the polyamine becomes protonated (thus being cationic).

Advantageously, a homogeneous hydrogel may be synthesized with the weight ratio between the polyacid and the polyamine. This creates a solid structure that allows an effective dispersion of materials, such as active electrode materials or conductive additives in the hydrogel binder.

In the method, the weight ratio between the polyacid and the polyamine may be in the range of about 10:100 to about 40:100, about 30:100 to about 40:100, about 35:100 to about 40:100, about 20:100 to about 35:100, about 20:100 to about 40:100, about 15:100 to about 30:100 or about 10:100 to about 25:100.

In the method, the weight ratio between the polyacid and the polyamine may be about 24:100.

In the method, the solvent may dissolve the polyacid and the polyamine. Exemplary solvents may be water, N-methyl-2-pyrrolidone or combinations thereof.

In the method, the solvent may be an aqueous medium. In the hydrogel binder, the solvent may be water.

In the method, the polyacid may be a polycarboxylic acid or a polysulfonic acid, or a combination thereof. The polyacid may be alginic acid, hyaluronic acid, polyacrylic acid, polymethacrylic acid, polystyrenesulfonic acid, polyvinylsulfonic acid or a salt or any combination thereof.

In the method, the polyacid may be alginic acid or a salt thereof.

In the method, the polyamine may be polyethyleneimine, chitosan, polyacrylamine, or a salt or any combinations thereof.

In the method, the polyamine may be polyethyleneimine or a salt thereof.

In the method, the polyacid and the polyamine may have a combined concentration in the solvent in the range of about 30 mg/mL to 125 mg/mL, 100 mg/mL to about 200 mg/mL, about 125 mg/mL to about 200 mg/mL, about 150 mg/mL to about 200 mg/mL, about 175 mg/mL to about 200 mg/mL, about 100 mg/mL to about 175 mg/mL, about 100 mg/mL to about 150 mg/mL, about 100 mg/mL to about 125 mg/mL or about 125 mg/mL to about 150 mg/mL.

In the method, the polyacid and the polyamine may have a combined concentration of about 140 mg/mL in the solvent.

Exemplary, non-limiting embodiments of a free-standing electrode will now be disclosed.

The free-standing electrode comprises a hydrogel binder and carbon nanotubes, wherein the hydrogel binder comprises an anionic polyacid and a cationic polyamine, wherein the anionic polyacid and the cationic polyamine are derived from an acid-base reaction between a polyacid and a polyamine at a weight ratio in the range of about 10:100 to about 40:100.

In the acid-base reaction, the weight ratio between the polyacid and the polyamine may be in the range of about 10:100 to 30:100, 25:100 to about 40:100, about 30:100 to about 40:100, about 35:100 to about 40:100, about 20:100 to about 35:100, about 20:100 to about 40:100, about 20:100 to about 30:100 or about 20:100 to about 25:100.

In the acid-base reaction, the weight ratio between the polyacid and the polyamine may be about 24:100.

The type of polyacid and polyamine used in the acid-base reaction is as described above.

In the free-standing electrode, the anionic polyacid in the hydrogel may be an anionic polycarboxylic acid or an anionic polysulfonic acid, or a combination thereof. The anionic polyacid may be anionic alginic acid, anionic hyaluronic acid, anionic polyacrylic acid, anionic polymethacrylic acid, anionic polystyrenesulfonic acid, anionic polyvinylsulfonic acid any combination thereof.

In the free-standing electrode, the anionic polyacid in the hydrogel binder may be alginic acid.

In the free-standing electrode, the cationic polyamine in the hydrogel may be cationic polyethyleneimine, cationic chitosan, cationic polyacrylamine, or any combinations thereof.

In the free-standing electrode, the cationic polyamine in the hydrogel binder may be cationic polyethyleneimine.

In the free-standing electrode, the hydrogel binder may be made from, obtained from or obtainable from a method comprising mixing a polyacid and a polyamine at a weight ratio in the range of about 20:100 to about 40:100 in a solvent.

In the free-standing electrode, the hydrogel binder may be made according to the method as described herein.

In the free-standing electrode, the carbon nanotubes may be single-wall carbon nanotubes or double-wall carbon nanotubes.

The free-standing electrode may further comprise a conductive additive. The conductive additive is not particularly limited and exemplary conductive additives may comprise graphene, graphene oxide, reduced graphene oxide, carbon fibre, carbon black or combinations thereof.

The free-standing electrode may further comprise an active electrode material. The active electrode material is not particularly limited and exemplary active electrode materials include transition metal oxides, phosphate salts of lithium and a transition metal, metalloids or combinations thereof.

In the active electrode material, the transition metal is not particularly limited and exemplary transition metals may be V, Ni, Fe, Co, Mn, Ti, Sn, Ni, Zn, Cu or combinations thereof.

In the active electrode material, the metalloid is not particularly limited and exemplary metalloids may be silicon, germanium, boron, arsenic, antimony, tellurium or combinations thereof.

Where the active electrode material is a transition metal oxide, the transition metal oxide may be titanium dioxide (TiO₂), tin (IV) oxide/rGO (SnO₂/rGO), cobalt (II,III) oxide (CO₃O₄), manganese dioxide (MnO₂), manganese (III) oxide (Mn₂O₃), nickel oxide (NiO), zinc oxide (ZnO), iron (III) oxide (Fe₂O₃), MnCo₂O₄, CuCo₂O₄, NiCo₂O₄, ZnMn₂O₄, ZnCo₂O₄, CoFe₂O₄ or combinations thereof.

Where the active electrode material is a metalloid, the metalloid may be silicon, germanium, boron, arsenic, antimony, tellurium or combinations thereof.

Where the active electrode material is a phosphate salt of lithium and a transition metal, the active electrode material may be lithium iron phosphate (LiFePO₄), lithium cobalt phosphate (LiCoPO₄), lithium manganese phosphate (LiMnPO₄), or lithium nickel phosphate (LiNiPO₄). As lithium iron phosphate has an olivine structure, other possible active electrode materials that can be used may be materials that have an olivine structure such as AMPO₄ (where A is an alkali metal and M is a combination of Co, Mn and/or Ni), LiM₁₋ₓFePO₄, wherein 0<x<1, and LiFePO_{4-z}M, wherein 0<z<1.

The active electrode material may additionally or alternatively be a standard layered oxide having a formula of LiNiₓCo_{y}Mn_{z}O₂, wherein x+y+z=1.

The active electrode material may additionally or alternatively be lithium-rich lithium manganese nickel oxide having a formula of Li[Li_{1/3-2x/3}NiₓMn_{2/3-x/3}]O₂, wherein 0<x<0.5.

The active electrode material may additionally or alternatively be a lithium nickel cobalt aluminium oxide.

The active electrode material may additionally or alternatively be a high voltage spinel lithium nickel manganese oxide having a formula of LiMn_{1.5}Ni_{0.5}O₄.

Advantageously, the hydrogel binder may effectively disperse the electrochemically active material(s) and conductive additive(s) in the free-standing electrode. This may eliminate the need for metallic current collectors when the free-standing electrode is made into batteries.

Where the free-standing electrode comprises the active electrode material, the free-standing electrode may function independently in batteries such as lithium-ion batteries. Where the free-standing electrode does not comprise the active electrode material, the free-standing electrode may host other materials such as sulfur to make batteries such as lithium sulfur batteries. Therefore, the free-standing electrode may also be considered a carbon scaffold/sulfur host electrode when used in lithium sulfur batteries.

Exemplary, non-limiting embodiments of a method of preparing a free-standing electrode will now be disclosed.

The method comprises the steps of:
a) mixing a hydrogel binder and carbon nanotubes in a mixing solvent to form a slurry, wherein the hydrogel binder comprises anionic polyacid and a cationic polyamine, wherein the anionic polyacid and the cationic polyamine are derived from an acid-base reaction between a polyacid and a polyamine at a weight ratio in the range of about 10:100 to about 40:100 and a solvent; and
b) casting and drying the slurry of step (a) on a substrate to form the free-standing electrode.

Advantageously, a hydrogel binder has a solid structure that allows an effective dispersion of materials to make the free-standing electrode. The free-standing electrode may eliminate the need for metallic current collectors when made into batteries.

Further advantageously, this method does not require special equipment or laborious techniques.

In the mixing step (a), the weight ratio between the polyacid and the polyamine in the acid-base reaction may be in the range of about 10:100 to about 30:100, 25:100 to about 40:100, about 30:100 to about 40:100, about 35:100 to about 40:100, about 20:100 to about 35:100, about 20:100 to about 40:100, about 20:100 to about 30:100 or about 20:100 to about 25:100.

In the mixing step (a), the weight ratio between the polyacid and the polyamine in the acid-base reaction may be about 24:100.

The type of polyacid and polyamine used in the acid-base reaction is as described above. In the mixing step (a), the mixing solvent used is not particularly limited and exemplary solvents may be water, N-methyl-2-pyrrolidone or combinations thereof.

In the mixing step (a), the solvent in the hydrogel may be an aqueous medium. In the mixing step (a), the solvent in the hydrogel may be water. In the mixing step (a), the mixing solvent may be a combination of water and N-methyl-2-pyrrolidone at a volume ratio of 1:1.

In the mixing step (a), the anionic polyacid of the hydrogel binder may be an anionic polycarboxylic acid or an anionic polysulfonic acid, or a combination thereof. The anionic polyacid may be anionic alginic acid, anionic hyaluronic acid, anionic polyacrylic acid, anionic polymethacrylic acid, anionic polystyrenesulfonic acid, anionic polyvinylsulfonic acid, or any combination thereof.

In the mixing step (a), the anionic polyacid of the hydrogel binder may be anionic alginic acid.

In the mixing step (a), the cationic polyamine of the hydrogel binder may be cationic polyethyleneimine, cationic chitosan, cationic polyacrylamine, or any combination thereof.

In the mixing step (a), the cationic polyamine of the hydrogel binder may be cationic polyethyleneimine.

The method may comprise, before mixing step (a), the step of (a1) mixing the polyacid and the polyamine at a weight ratio in the range of about 10:100 to about 40:100 in the solvent to form the hydrogel binder. In the mixing step (a1), the polyacid and the polyamine may have a combined concentration in the solvent in the range of about 30 mg/mL to about 125 mg/mL, about 100 mg/mL to about 200 mg/mL, about 125 mg/mL to about 200 mg/mL, about 150 mg/mL to about 200 mg/mL, about 175 mg/mL to about 200 mg/mL, about 100 mg/mL to about 175 mg/mL, about 100 mg/mL to about 150 mg/mL, about 100 mg/mL to about 125 mg/mL or about 125 mg/mL to about 150 mg/mL.

In the mixing step (a1), the polyacid and the polyamine may have a combined concentration of about 140 mg/mL in the solvent.

In the method, the mixing step (a) may further comprise mixing the slurry with a conductive additive. The conductive additive used is not particularly limited and exemplary conductive additives may comprise graphene, graphene oxide, reduced graphene oxide, carbon fibre, carbon black or combinations thereof.

In the method, the mixing step (a) may further comprise mixing the slurry with an active electrode material.

The active electrode material is not particularly limited and exemplary active electrode materials include transition metal oxides, phosphate salts of lithium and a transition metal, metalloids or combinations thereof.

In the active electrode material, the transition metal is not particularly limited and exemplary transition metals may be V, Ni, Fe, Co, Mn, Ti, Sn, Ni, Zn, Cu or combinations thereof.

Where the active electrode material is a transition metal oxide, the transition metal oxide may be titanium dioxide (TiO₂), tin (IV) oxide/rGO (SnO₂/rGO), cobalt (II,III) oxide (CO₃O₄), manganese dioxide (MnO₂), manganese (III) oxide (Mn₂O₃), nickel oxide (NiO), zinc oxide (ZnO), iron (III) oxide (Fe₂O₃), MnCo₂O₄, CuCo₂O₄, NiCo₂O₄, ZnMn₂O₄, ZnCo₂O₄, CoFe₂O₄ or combinations thereof.

In the active electrode material, the metalloid is not particularly limited and exemplary semi-metals may be silicon, germanium, boron, arsenic, antimony, tellurium or combinations thereof.

Where the active electrode material is a phosphate salt of lithium and a transition metal, the active electrode material may be lithium iron phosphate (LiFePO₄), lithium cobalt phosphate (LiCoPO₄), lithium manganese phosphate (LiMnPO₄), or lithium nickel phosphate (LiNiPO₄). As lithium iron phosphate has an olivine structure, other possible active electrode materials that can be used may be materials that have an olivine structure such as AMPO₄ (where A is an alkali metal and M is a combination of Co, Mn and/or Ni), LiM₁₋ₓFePO₄, wherein 0<x<1, and LiFePO_{4-z}M, wherein 0<z<1.

The active electrode material may additionally or alternatively be a standard layered oxide having a formula of LiNiₓCo_{y}Mn_{z}O₂, wherein x+y+z=1.

The active electrode material may additionally or alternatively be lithium-rich lithium manganese nickel oxide having a formula of Li[Li_{1/3-2x/3}NiₓMn_{2/3-x/3}]O₂, wherein 0<x<0.5.

The active electrode material may additionally or alternatively be a lithium nickel cobalt aluminium oxide.

The active electrode material may additionally or alternatively be a high voltage spinel lithium nickel manganese oxide having a formula of LiMn_{1.5}Ni_{0.5}O₄.

Where the active electrode material is added, the free-standing electrode may function independently in batteries such as lithium-ion batteries. Where the active electrode material is not added, the free-standing electrode may host other materials such as sulfur to make batteries such as lithium sulfur batteries. Therefore, the free-standing electrode may also be considered a carbon scaffold/sulfur host electrode when used in lithium sulfur batteries.

In the mixing step (a), the mixing may be undertaken by milling, stirring or combinations thereof. The milling may be ball milling. The ball milling may be undertaken with stainless steel 440C balls having a diameter in the range of about 4 mm to about 6 mm, about 4 mm to about 5 mm or about 5 mm to about 6 mm.

The mixing may be undertaken for a duration in the range of about 20 minutes to about 40 minutes, about 25 minutes to about 40 minutes, about 30 minutes to about 40 minutes, about 35 minutes to about 40 minutes, about 20 minutes to about 35 minutes, about 20 minutes to about 30 minutes, about 20 minutes to about 25 minutes or about 25 minutes to about 35 minutes.

In the casting and drying step (b), the substrate used is not particularly limited and exemplary substrates include a Mylar film, a polyimide film, a polypropylene film or combinations thereof.

The drying of the slurry may be undertaken at a temperature in the range of about 60° C. to about 100° C., about 70° C. to about 100° C., about 80° C. to about 100° C., about 90° C. to about 100° C., about 60° C. to about 90° C., about 60° C. to about 80° C., about 60° C. to about 70° C. or about 70° C. to about 90° C.

The drying of the slurry may be undertaken for a duration in the range of about 2 hours to about 12 hours, about 6 hours to about 12 hours, about 10 hours to about 12 hours, about 2 hours to about 10 hours, about 2 hours to about 6 hours or until the slurry is essentially free of the mixing solvent and the milling solvent.

The dried slurry may be in the form of a film. The film may be peeled off from the substrate. The film may be used as the free-standing electrode.

Where the method comprises a step of, before mixing step (a), the step of (a1) mixing the polyacid and the polyamine at a weight ratio in the range of about 10:100 to about 40:100 in the solvent to form the hydrogel binder, the method of preparing a free-standing electrode can be regarded as comprising the steps of:
a1) mixing a polyacid and a polyamine in an acid-base reaction at a weight ratio in the range of about 10:100 to about 40:100 in a solvent to form a hydrogel binder, wherein the hydrogel binder comprises an anionic polyacid from the polyacid and a cationic polyamine from the polyamine;
a) mixing the hydrogel binder and carbon nanotubes in a mixing solvent to form a slurry; and
b) casting and drying the slurry of step (a) on a substrate to form the free-standing electrode.

Exemplary, non-limiting embodiments of a battery will now be disclosed.

The battery may comprise the free-standing electrode as described herein, a sulfur source, a separator and an electrolyte. The free-standing electrode in the battery may not comprise an active electrode material. Therefore, the battery may be a lithium sulfur battery. In the battery, the free-standing electrode may be a cathode and a lithium foil may be an anode or reference electrode.

In the battery, the sulfur source may be a polysulfide having a formula of Li₂Sₓ, wherein x is a number in the range of about 4 to about 8, about 4 to about 6 or about 6 to about 8. The polysulfide may have a formula of Li₂S₆. The sulfur source may additionally or alternatively be elemental sulfur. The elemental sulfur may be integrated into the battery by vapor diffusion or melt diffusion.

In the battery, the separator may be a combination of a glass fiber membrane and a Celgard membrane.

The glass fiber membrane may have a coating on its surface consisting of vapor-grown carbon fibers and the hydrogel binder as described herein. The coating may have a density in the range of about 0.3 mg/cm² to about 0.7 mg/cm², about 0.4 mg/cm² to about 0.7 mg/cm², about 0.5 mg/cm² to about 0.7 mg/cm², about 0.6 mg/cm² to about 0.7 mg/cm², about 0.3 mg/cm² to about 0.6 mg/cm², about 0.3 mg/cm² to about 0.5 mg/cm², about 0.3 mg/cm² to about 0.4 mg/cm² or about 0.4 mg/cm² to about 0.6 mg/cm².

In the coating, the vapor-grown carbon fibers and the hydrogel binder may have a weight ratio in the range of about 80:20 to about 99:1, about 90:10 to about 99:1 or about 80:20 to about 90:10.

The Celgard membrane may be a Celgard 2325 membrane.

In the battery, the electrolyte may comprise a lithium salt and a solvent.

In the electrolyte, the lithium salt is not particularly limited and exemplary lithium salts may be Bis(trifluoromethane)sulfonimide lithium salt (LiTFSI), lithium nitrate (LiNO₃), lithium hexafluorophosphate (LiPF₆), lithium tetrafluoroborate (LiBF₄), lithium bis(fluorosulfonyl)imide, lithium difluoro(oxalato)borate, lithium bis(oxalato)borate or combinations thereof.

In the electrolyte, the lithium salt may be a combination of LiTFSI and LiNO₃ with a molar ratio in the range of about 2:1 to about 4:1, about 3:1 to about 4:1 or about 2:1 to about 3:1.

In the electrolyte, the lithium salt may be a combination of LiTFSI and LiNO₃ with a molar ratio of about 10:3.

In the electrolyte, the solvent is not particularly limited and exemplary solvents include dimethoxyethane (DME), dioxolane (DOL), propylene carbonate, gamma-butyrolactone, diethylene carbonate, fluoroethylene carbonate, sulfones, room temperature ionic liquids like 1-Methyl-1-propylpiperidinium bis(trifluoromethylsulfonyl)imide, 1-Methyl-1-propylpiperidinium Bis(fluorosulfonyl)imide or combinations thereof.

In the electrolyte, the lithium salt may have a concentration in the range of about 0.5 M to about 2 M, about 1 M to about 2 M, about 1.5 M to about 2 M, about 0.5 M to about 1.5 M, about 0.5 M to about 1 M or about 1 M to about 1.5 M.

Exemplary, non-limiting embodiments of a battery will now be disclosed.

The battery may comprise at least one free-standing electrode as described herein, a separator and an electrolyte. The free-standing electrode in the battery may comprise an active electrode material. Therefore, the battery may be a lithium-ion battery.

In the battery, the separator may be a Celgard membrane. The Celgard membrane may be a Celgard 2325 membrane.

In the battery, the electrolyte may comprise a lithium salt and a solvent.

In the electrolyte, the lithium salt is not particularly limited and exemplary lithium salts may be Bis(trifluoromethane)sulfonimide lithium salt (LiTFSI), lithium nitrate (LiNO₃), lithium hexafluorophosphate (LiPF₆), lithium tetrafluoroborate (LiBF₄), lithium bis(fluorosulfonyl)imide, lithium difluoro(oxalato)borate, lithium bis(oxalato)borate or combinations thereof.

In the electrolyte, the lithium salt may be a combination of LiTFSI and LiNO₃ with a molar ratio in the range of about 1:1 to about 4:1, about 3:1 to about 4:1 or about 2:1 to about 3:1.

In the electrolyte, the lithium salt may be a combination of LiTFSI and LiNO₃ with a molar ratio of about 10:3.

In the electrolyte, the solvent is not particularly limited and exemplary solvents include dimethoxyethane (DME), dioxolane (DOL), propylene carbonate, gamma-butyrolactone, diethylene carbonate, fluoroethylene carbonate, sulfones, room temperature ionic liquids like 1-Methyl-1-propylpiperidinium bis(trifluoromethylsulfonyl)imide, 1-Methyl-1-propylpiperidinium Bis(fluorosulfonyl)imide or combinations thereof.

In the electrolyte, the lithium salt may have a concentration in the range of about 0.5 M to about 2 M, about 1 M to about 2 M, about 1.5 M to about 2 M, about 0.5 M to about 1.5 M, about 0.5 M to about 1 M or about 1 M to about 1.5 M.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1a is a schematic diagram of a general procedure for preparing free-standing electrodes that may be used in lithium-ion batteries (LIB) or lithium sulfur batteries (LSB). In FIG. 1a, Polyethyleneimine (PEI) 2 and alginic acid (Alg) 4 are mixed to form a hydrogel binder (PA) 10. The hydrogel binder may then be mixed with single-wall carbon nanotubes 14 and an optional conductive additive such as N-doped reduced graphene oxide 12 or vapor-grown carbon fibers 16, such as via ball milling 18 to form a slurry 20. An active electrode material, such as lithium iron phosphate 6 or TiO₂/SnO₂ nanosheets 8 (which may be doped with reduced graphene oxide) may be optionally milled together with the hydrogel binder. The slurry may be cast and dried to form the free-standing electrodes. Where the free-standing electrode comprises an active electrode material, it may be made into lithium-ion batteries 100 that comprise lithium 22 and the electrode 26. Where the free-standing electrode does not comprise an active electrode material, it may be made into lithium sulfur batteries 200 that comprise lithium 22 and an electrode 28 as a mixture of the free-standing electrode and sulfur 24.

FIG. 1b shows detailed structures of the hydrogel binder 10, when formed from a polyacid and a polyamine. When in the hydrogel state, the polyacid loses a hydrogen atom to form an anionic polyacid while the polyamine acquires a hydrogen atom to form a cationic polyamine, whereby the anionic polyacid and cationic polyamine are linked to each other via ionic interactions. In FIG. 1b, the anionic polyacid is shown as being an anionic polycarboxylic acid and/or anionic polysulfonic acid.

FIG. 2a shows images of inverted tubes containing 250 mg PEI with (i) 8 mg acetic acid, (ii) 10 mg, (iii) 20 mg, (iv) 30 mg and (v) 60 mg Alg. The hydrogel binders are marked with arrows. White arrows are for hydrogel binders where no gellation occurred and black arrows are for hydrogel binders where gellation occurred. FIG. 2b shows FTIR spectra of PA (bottom), PEI (middle) and Alg (top).

FIG. 3a and FIG. 3b are scanning electron microscope (SEM) images of the top view of TiO₂ and SnO₂ anodes, respectively. FIG. 3c and FIG. 3d are energy-dispersive X-ray (EDX) maps of TiO₂ and SnO₂ anodes, respectively, for C, 0, Ti or Sn as compared with the SEM images. FIG. 3e and FIG. 3f are X-ray diffraction (XRD) patterns of TiO₂ and SnO₂ anodes, respectively when mixed with single-wall carbon nanotubes. In FIG. 3e and FIG. 3f, the top graphs correspond to the entire electrode while the middle graph is the standard pattern to confirm the crystal phases of the active materials of TiO₂ and SnO₂.

FIG. 4a and FIG. 4b are cyclic voltammograms of TiO₂ and SnO₂ anodes, respectively.

FIG. 4c and FIG. 4d are charge-discharge curves of TiO₂ and SnO₂ anodes, respectively, at the second cycle.

FIG. 4e and FIG. 4f show the rate and long-term cycling studies of TiO₂ and SnO₂ anodes, respectively.

FIG. 5a shows SEM images of a lithium iron phosphate (LFP) cathode of the disclosure, FIG. 5b EDX maps of C, O, Fe and P as compared with the SEM images of a LFP cathode of the disclosure, FIG. 5c XRD patterns of a LFP cathode of the disclosure, and FIG. 5d a cyclic voltammogram of a LFP cathode of the disclosure.

FIG. 5e are charge-discharge curves of the LFP cathode.

FIG. 5f shows rate and long-term studies of the LFP cathode.

FIG. 6a and FIG. 6b are SEM images of top and cross-section view of the carbon scaffold, respectively.

FIG. 6c shows EDX maps of C and 0 of the carbon scaffold as compared with the SEM images.

FIG. 6d shows XRD patterns of the carbon scaffold.

FIG. 6e shows a cyclic voltammogram of the carbon scaffold.

FIG. 6f shows rate and long-term cycling studies of the carbon scaffold at a S loading of 3.3 mg cm′.

FIG. 6g shows long-term cycling performance of the carbon scaffold at a S loading of 6.6 mg cm⁻² for LSB.

### EXAMPLES

Non-limiting examples of the invention will be further described in greater detail by reference to specific Examples, which should not be construed as in any way limiting the scope of the invention.

### Example 1— Synthesis of a Hydrogel Binder

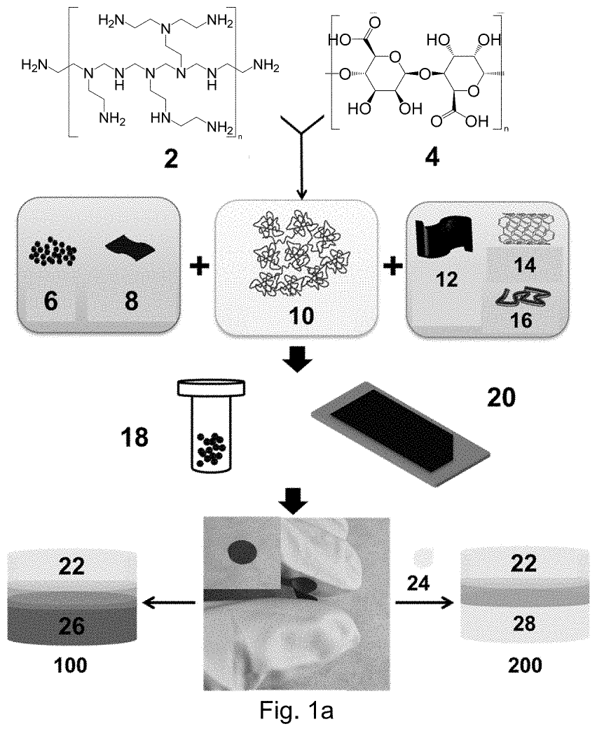

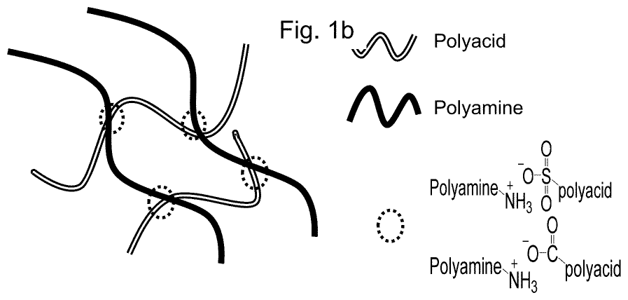

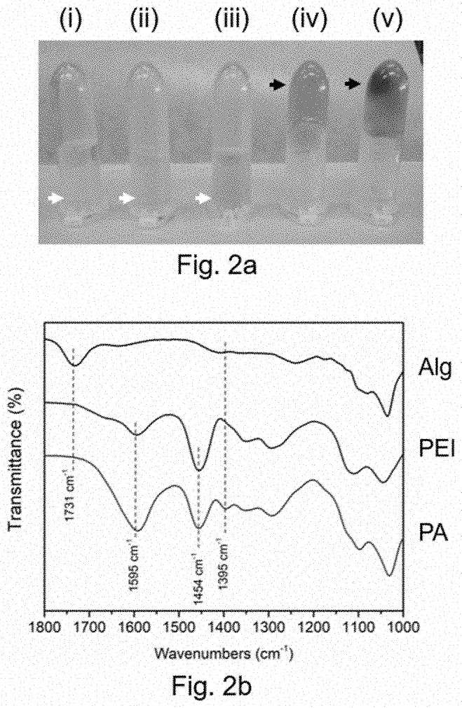

A yellow hydrogel binder (PA) was prepared by adding alginic acid (Alg, purchased from Sigma Aldrich Pte Ltd, Singapore) to an aqueous solution of polyethyleneimine (PEI, purchased from Sigma Aldrich Pte Ltd, Singapore). While both Alg and PEI are common polymers used as binders for electrode preparation, their combination as a battery binder was not studied previously and could impart enhanced mechanical and/or dispersion properties to the free-standing structure via a cross-link network. The optimal amount of Alg to effect gelation was determined to be 30 mg (0.14 mmol) per 250 mg of PEI (see FIG. 2(a)(iv)). Too much Alg resulted in a heterogeneous gel (see FIG. 2(a)(v)). In contrast, the use of monoacid acetic acid (8 mg, 0.14 mmol, purchased from Merck Pte. Ltd., Singapore) did not result in gelation (see FIG. 2(a)(i), illustrating the critical role of Alg, which have free carboxylic acid groups along its polymeric chain, as a cross-linking agent for hydrogel formation with the free amine groups of PEI). The chemical structure of PA was examined and compared with starting materials PEI and Alg using FTIR spectroscopy (see FIG. 2b). 3 bands appeared in the PA spectrum: a band centered at 1395 cm⁻¹, a stronger band at 1454 cm⁻¹ and a broad band at 1595 cm⁻¹. The band at 1395 cm⁻¹, which was absent in both PEI and Alg spectra, could be assigned to symmetric O—C—O stretching vibration. The band at 1454 cm⁻¹ could be assigned to C—H bending vibration, which was also present in the PEI spectrum. The band at 1595 cm⁻¹ in the PA spectrum appeared broader and stronger in intensity than that in the PEI spectrum. This broad band could be assigned to a combination of N—H bending vibration from the contribution of PEI and the asymmetric O—C—O stretching vibration that is known to appear at about 1596 cm⁻¹. It was further noted that the peak at 1731 cm⁻¹, attributed to C═O stretching vibration mode in alginic acid, was found to be absent in PA. Taken together, these band assignments confirmed that the PA hydrogel consisted of ionic interactions formed between PEI and Alg. The resultant network structure held together by ionic cross-linkages would allow effective dispersion of the carbon structures used within the LIB and LSB electrodes. In summary, 30 mg of Alg was added to 250 mg of PEI (50 weight %) in 1 mL H₂O, and ball-milled to obtain the PA hydrogel. As shown in FIG. 1b, the PA hydrogel binder had ionic linkages between the PEI (being the polyamine in FIG. 1b) and the Alg (being the polyacid in FIG. 1b).

### Example 2— Preparation of a Free-Standing Electrode

Free-standing electrodes were synthesized according to FIG. 1a.

Single-wall carbon nanotubes (SWCNT, purchased from Nanjing JCNANO Technology Co. Ltd.) were used for lithium-ion battery (LIB) and lithium sulfur battery (LSB) electrodes to enhance electrode mechanical properties, such as flexibility and strength, and provide electronic pathways throughout the entire free-standing electrodes. In the LSB cathode, vapor-grown carbon fiber (VGCF, purchased from Zhongke Leiming (Beijing) Science and Technology Co. Ltd.) and N-doped reduced graphene oxide (rGO, purchased from Nanjing JCNANO Technology Co. Ltd.) were added to SWCNT forming a sulfur host matrix with enhanced mechanical support, and provided abundant active sites for reversible electrochemical processes between sulfur and lithium sulfide. In addition, the PA hydrogel binder possessed rich functional groups, such as amine, hydroxyl and carboxyl groups, which could impart beneficial properties such as more efficient Li⁺ conduction via electrostatic interactions and polysulfide trapping especially for LSB with high sulfur loading. More importantly, as compared to the conventional polyvinylidene fluoride, the PA hydrogel binder is water processable and therefore, more environmentally friendly. The PA hydrogel, active material and conductive carbon additives (SWCNT, VGCF and rGO) were ball-milled (using stainless steel 440C, 5 mm diameter procured from ANR Technologies Pte Ltd, Singapore) in a NMP/H₂O solution (purchased from Sigma Aldrich Pte. Ltd, Singapore) using a benchtop vortex for 30 minutes (FIG. 1a). The resulting slurry mixture was cast on a Mylar® film (purchased from RS Components Pte. Ltd, Singapore) and dried in an oven at 80° C. After drying, the dried slurry was carefully peeled off from the Mylar® film to obtain the free-standing electrode. The detailed experimental protocol is described below.

For TiO₂ and SnO₂ anodes, 38 mg of the hydrogel was ball-milled with 10 mg of SWCNT and 20 mg of either TiO₂ or SnO₂ nanosheet material.

The TiO₂ nanosheets were synthesized by mixing a graphene oxide template and Ti(IV) butoxide (purchased from Sigma-Aldrich of Saint Louis, Mo. of the United States of America) at a molar/weight ratio of 1:8 as precursor, followed by washing thoroughly to remove excess Ti butoxide, and drying at 60° C. to get a precursor. Finally, the precursor was calcined at a temperature of 500° C. for a duration of 1 hour in air.

The SnO₂ nanosheets were synthesized by mixing a graphene oxide template and dibutyltin dilaurate (purchased from Sigma-Aldrich of Saint Louis, Mo. of the United States of America) at a molar/weight ratio of 1:16 as precursor, followed by washing thoroughly to remove excess dibutyltin dilaurate, and drying at 60° C. to get a precursor. Finally, the precursor was calcined at a temperature of 300-350° C. for a duration of 1 hour in air.

For lithium iron phosphate (LFP) cathode, 38 mg of the hydrogel was ball-milled with 10 mg of SWCNT and 60 mg of LFP (50 μm thickness, purchased from Kaiyuen Huineng (Sichuan) Co. Ltd, China). For the carbon scaffold/sulfur host electrode, 38 mg of hydrogel was ball-milled with 40 mg of rGO, 5 mg of VGCF and 5 mg of SWCNT. Ball milling was carried out in a 1:1 NMP/H₂O solvent mixture using a vortex mixer for about 30 minutes. The resulting slurry was coated on a Mylar® film, and dried in an 80° C. oven. A free-standing electrode was obtained by peeling the dried slurry off the film.

### Example 3— Preparation of an Electrolyte and a Polysulfide Solution

The electrolyte for batteries was prepared by adding 1 M LiTFSI and 2 wt % LiNO₃ (both purchased from Sigma Aldrich Pte Ltd, Singapore) to a mixture of dioxolane (DOL) and dimethoxyethane (DME) (both purchased from Sigma Aldrich Pte Ltd, Singapore, volume ratio of 1:1). Li₂S₆ solution was prepared by stirring a mixture of S (160.5 mg, purchased from Sigma Aldrich Pte Ltd, Singapore) and Li₂S (46.0 mg, purchased from Sigma Aldrich Pte Ltd, Singapore) at 50° C. overnight in 1 mL of electrolyte solution in an Ar—filled glovebox to obtain a viscous orange solution. The electrolyte to sulfur (E/S) ratio was 5.8 μL/mg.

### Example 4— Testing of Free-Standing Anodes for Lithium-Ion Batteries

Free-standing anodes for LIB were prepared using the approach as illustrated in FIG. 1a. Transition metal oxides are promising alternatives to graphite as anode material due to their higher safety profile, such as intercalation-type oxides, and higher energy density, such as conversion-type oxides. It has been previously demonstrated that metal oxides with a nanosheet morphology showed excellent electrochemical energy storage performance. Both TiO₂ and SnO₂/rGO nanosheets were chosen as representative anode materials and were prepared via a facile graphene oxide-templated approach. Together with PA hydrogel as binder and SWCNT as both conductive additive and structural support, these nanosheet materials were used as active material to obtain free-standing and flexible TiO₂ and SnO₂ anodes.

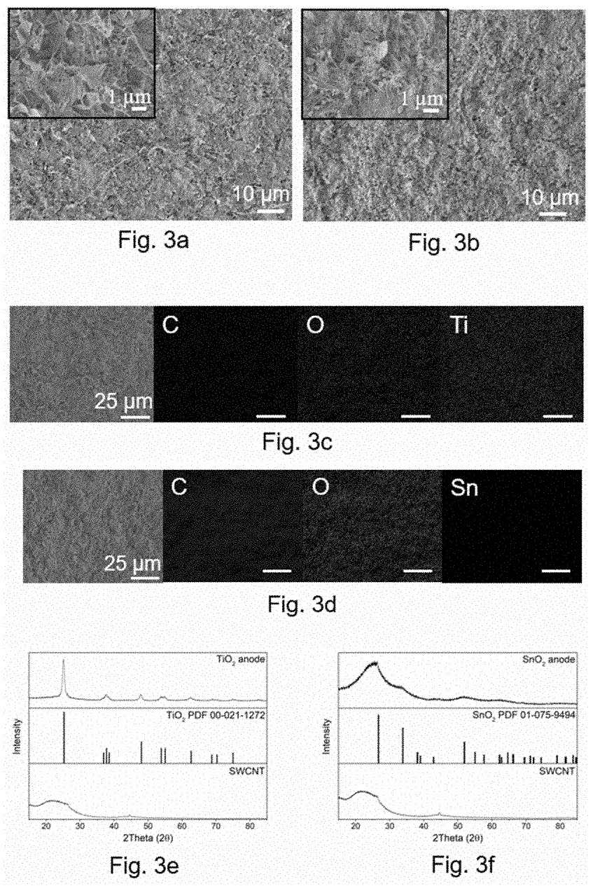

The microstructure of the anodes was examined using field-emission scanning electron microscopy (FESEM), which showed excellent dispersion of the metal oxide nanosheet within the SWCNT network (see FIG. 3a and FIG. 3b). This was confirmed by energy-dispersive X-ray spectroscopy (EDX) elemental mapping, which revealed a homogeneous distribution of Ti, O and C in the TiO₂ anode, and Sn, O and C in the SnO₂ anode (see FIG. 3c and FIG. 3d). The anodes were further analyzed using powder X-ray diffraction (XRD). XRD pattern of the TiO₂ anode revealed diffraction peaks attributed to anatase TiO₂ (PDF: 00-021-1272, crystallite size=12.2 nm) (see FIG. 3e). The diffraction band attributed to SWCNT (20 was about 26°) probably overlapped with the strong XRD signal of TiO₂ at 20=25.3°. XRD pattern of the SnO₂ anode revealed the presence of diffraction peaks attributed to rutile SnO₂ (PDF: 01-075-9494, crystallite size=3.5 nm), together with the characteristic diffraction peak (20=26.6°) of the rGO component in the SnO₂/rGO anode material (FIG. 20. The diffraction peak attributed to SWCNT overlapped with the broad rGO peak centered at 2θ at about 26°.

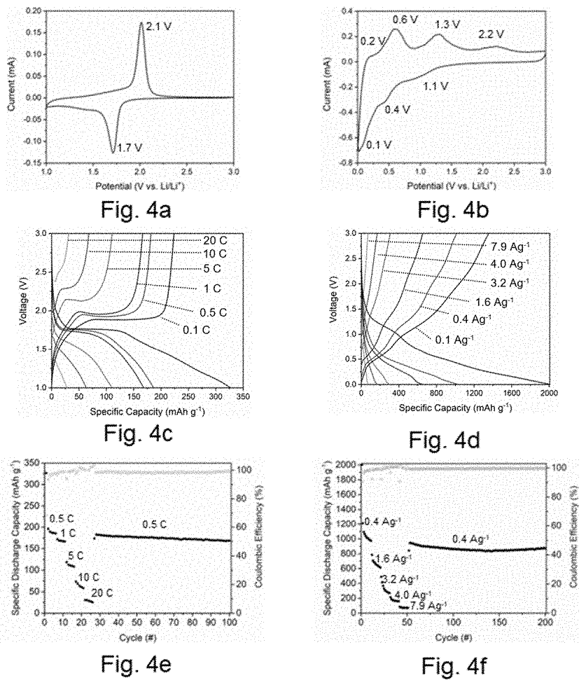

The electrochemical performances of both anodes were evaluated using cyclic voltammetry (CV) and galvanostatic cycling (GC). For the CV curve of the TiO₂ anode in FIG. 4a, two main peaks appeared at about 1.7 V and about 2.1 V, corresponding to the reduction and oxidation processes, respectively. The lithium insertion/extraction mechanisms associated with these redox processes are well-documented in literature. The reduction peak at 1.7 V was attributed to Li⁺ insertion process into TiO₂ to form Li-rich phases. The gentle slope observed after the reduction peak of <1.7 V in FIG. 4a was determined to be interfacial Li⁺ storage. Conversely, for the oxidation process, the gentle slope between 1.0 V and 1.9 V was attributed to interfacial Li⁺ extraction. Subsequent Li⁺ extraction from bulk Li-rich TiO₂ to TiO₂ occurred at about 2.1 V. Charge-discharge curves revealed a continuous plateau that corresponded to intercalation/de-intercalation of Li⁺ into TiO₂ (see FIG. 4c). Increasing C rate resulted in a shortening of the plateau and specific capacity due to increasing polarization. Rate capability and long-term cycling studies revealed the excellent electrochemical performance of the free-standing TiO₂ anode (see FIG. 4e). The high initial discharge capacity of 327 mAh g⁻¹ and low initial Coulombic efficiency (CE) of 60% could be attributed to irreversible processes, such as solid electrolyte interphase (SEI) formation, reduction of surface functional groups on SWCNT. Average discharge capacities at 0.5° C., 1.0° C., 5.0° C., 10.0° C. and 20.0° C. were 187, 168, 110, 65 and 28 mAh g⁻¹, respectively (see FIG. 4e). The discharge capacity after 100 cycles at 0.5° C. was determined to be 168 mAh g⁻¹, corresponding to a high capacity retention of about 90% and a high CE of >98%, indicating excellent reversibility and fast kinetics of the free-standing TiO₂ anode (see FIG. 4e).

Unlike TiO₂, which operated via an intercalation mechanism, lithiation/de-lithiation of SnO₂ involved a two-step process that could be assigned to the CV peaks in FIG. 3b. The reduction peaks at about 1.1 V and about 0.4 V corresponded to the reduction of SnO₂ to metallic Sn and the subsequent formation of alloy Sn—Liₓ (0<x<4.4), respectively. In addition, the peak at about 0.1 V corresponded to lithiation of graphene and SWCNT. For the reverse scan, the oxidation peak at about 0.2 V corresponded to the de-lithiation of graphene and SWCNT, while the oxidation peaks at about 0.6 V, about 1.3 V and about 2.2 V corresponded to the de-alloying of Sn—Liₓ, oxidation of Sn to SnO, and SnO to SnO₂, respectively.

The SnO₂ anode was further evaluated under galvanostatic conditions. The high initial discharge capacity (2004 mAh g⁻¹) and a low Coloumbic efficiency of about 67% in the 1st cycle were attributed to SEI formation, consistent with other reports (see FIG. 4d). Charge-discharge curves revealed a typical profile of an SnO₂ electrode—three short plateaus that corresponded to redox reaction from SnO₂ to Sn via SnO, and alloy/de-alloying of Sn—Liₓ (0<x<4.4) (see FIG. 4d). The increase in current density (A g⁻¹) resulted in a decrease in specific capacity due to the increase in polarization. Average discharge capacities at 0.4, 1.6, 3.2, 4.0 and 7.9 A g⁻¹ were 1019, 655, 315, 169 and 73 mAh g⁻¹, respectively (see FIG. 40. A high discharge capacity of 872 mAh g⁻¹ was obtained after 200 cycles at 0.4 A g⁻¹, corresponding to a high retention of 84% (see FIG. 40. In addition, the CE remained consistently high (>99%) during cycling, indicating the high reversibility and efficient kinetics of the free-standing SnO₂ anode. The electrochemical performances of the free-standing TiO₂ and SnO₂ anodes were comparable earlier works on TiO₂ and SnO₂/rGO nanosheet coated on Cu current collector (see Table 1). Our free-standing anodes were attractive because they did not require the expensive and dense copper (8.96 g cm⁻²) current collector. This would decrease the electrode weight, leading to a significant increase (7× for TiO₂ and 13× for SnO₂) in electrode capacity of the anodes (see Table 1).

TABLE 1
Electrochemical performance of LIB electrodes.

| | | | | Specific | | |
|---|---|---|---|---|---|---|
| | | Areal | | Discharge | Electrode | |
| Electrode | Current | loading | | Capacity | Capacity | |
| material | Collector | (mg cm⁻²) | Rate | (mAh g⁻¹) | (mAh g⁻¹)^{a} | Reference |
| TiO2 | Cu | 0.39 | 0.5 C | 243 | 11 | [S1] |
| nanosheet | | | | | | |
| TiO2 | None | 1.35 | 0.5 C | 168 | 96 | This Work |
| nanosheet | | | | | | |
| SnO2/rGO | Cu | 0.31 | 400 | 1131 | 41 | [S1] |
| nanosheet | | | mAh g−1 | | | |
| SnO2/rGO | None | 0.90 | 400 | 1019 | 582 | This Work |
| nanosheet | | | mAh g−1 | | | |
| LFP | Al | ~12 | 0.2 C | 148 | 88 | Commercial^{b} |
| LFP | None | 6.36 | 0.2 C | 127 | 118 | This Work |

^{a}Based on total weight of electrode. Calculated using equations 1-3;
^{b}Based on specifications from MTI Corporation website (https://www.mtixtl.com/Li-IonBatteryCathode-AluminumfoilsinglesidecoatedbyLiFePO4267m-1.aspx)
$\begin{matrix}Electrode Capacity \\ ( mAh {g}^{- 1} )\end{matrix} = \frac{\begin{matrix}Specific Capacity ( mAh {g}^{- 1} ) \times \\ {wt}_{a c tive malerial} ( g )\end{matrix}}{w {t}_{electrode} ( g )} ( 1 )$ wt_{electrode} (g) = wt_{active material} (g) + wt_{carbon+binder} (g) + wt_{Al/Cu} (g) (2)
wt_{Al/Cu} (g) = 0 for free-standing electrodes (3)

### Example 5— Testing of Free-Standing Cathodes for Lithium-Ion Batteries

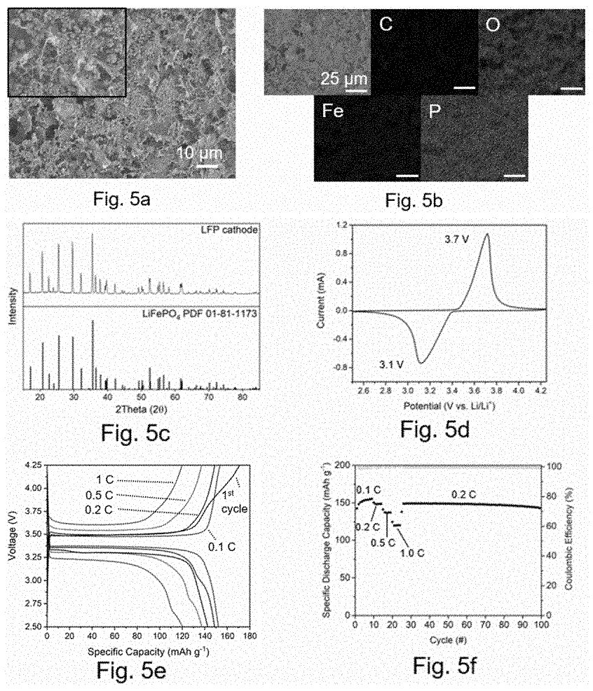

The versatility of this approach was further demonstrated in the preparation of free-standing cathodes for LIB. LFP was chosen as the representative cathode material due to its low cost, low toxicity, high safety and relatively high energy density. The LFP powder was ball-milled with the PA hydrogel binder and SWCNT to obtain the free-standing and flexible LFP cathode (see FIG. 1a). The microstructure of the LFP cathode revealed that the LFP particles were well-dispersed within the SWCNT matrix (see FIG. 5a). EDX mapping confirmed the homogeneous distribution of Fe, P, O and C throughout the cathode structure (see FIG. 5b). XRD pattern of the LFP cathode matched with that of olivine LiFePO₄ (PDF: 01-81-1173, crystallite size=50.6 nm) (see FIG. 5c). XRD peaks of the SWCNT in the LFP cathode might have been masked by the strong signal of LFP at 2θ of about 25°.

Electrochemical properties of the LFP cathode were evaluated using CV and GC. CV of the LFP cathode revealed a reduction peak at 3.1 V and an oxidation peak at 3.7 V, corresponding to Li⁺ insertion and extraction, respectively (see FIG. 5d). The irreversible capacity loss in the 1st cycle at 0.1° C. could be due to SEI formation (see FIG. 5e). Charge-discharge curves revealed a continuous plateau that corresponded to intercalation/de-intercalation of Li⁺ into LFP (see FIG. 5e). Increasing C rate resulted in a shortening of the plateau and battery capacity due to increasing polarization. Average discharge capacities at 0.1° C., 0.2° C., 0.5° C. and 1.0° C. were 153, 149, 138 and 121 mAh g⁻¹, respectively (see FIG. 5f). A high discharge capacity of 143 mAh g⁻¹ was obtained after 100 cycles at 0.2° C., corresponding to a high retention of 96% (see FIG. 5f). The CE also remained consistently high (>99%) during cycling. The high capacity retention and CE implied that electrochemical processes that occurred during battery cycling were highly reversible and efficient. Additionally, the lack of the Al current collector led to a˜34% higher electrode capacity, as compared to the commercial LFP electrode coated on the Al current collector (see Table 1).

### Example 6— Testing of Free-Standing Cathodes for Lithium Sulfur Batteries

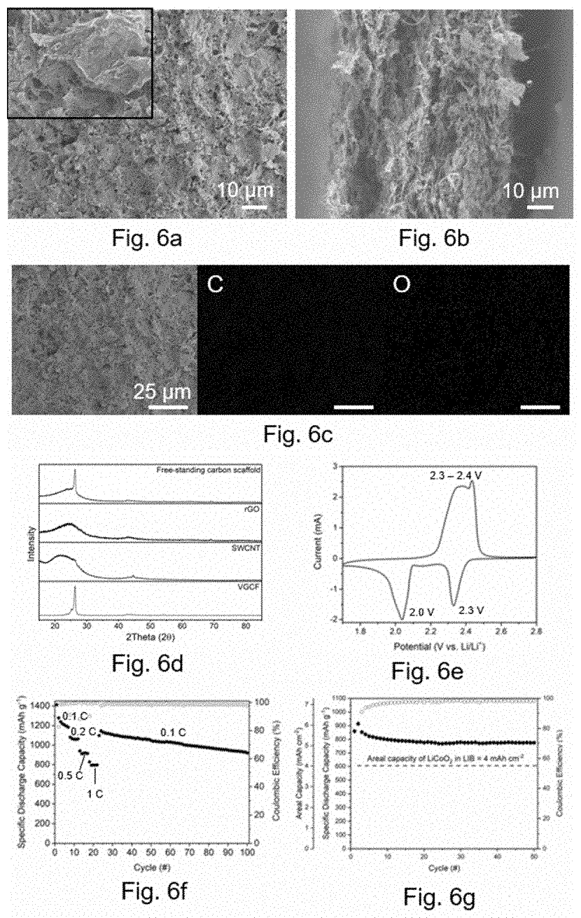

The methodology to prepare free-standing electrodes was extended to construct a conductive carbon scaffold as sulfur host in LSB. To mitigate the low conductivity of sulfur and polysulfide shuttling effect, the components of the carbon scaffold was chosen to be N-doped rGO, which has high surface area, high electrical conductivity and N sites for trapping polysulfide, VGCF and SWCNT to provide both mechanical support and high electrical conductivity, and PA hydrogel as binder. SEM of the free-standing sulfur host illustrated a porous 3D structure of sheet-like rGO that was interconnected by tube-like VGCF and SWCNT (see FIG. 6a and FIG. 6b). Elemental mapping revealed homogeneous distribution of carbon and oxygen throughout the structure, indicating that the components of the sulfur host were highly dispersed (see FIG. 6c). Previously it was shown that such a structure maximized surface area and electrical conductivity, giving rise to excellent electrochemical performance. XRD of the free-standing carbon scaffold showed a broad peak centered at 2θ of about 24° and a sharp peak at 2θ of about 26°, corresponding to the (002) planes of both rGO and SWCNT, and VGCF, respectively (see FIG. 6d). Li₂S₆ solution was added as a sulfur source into the carbon scaffold during battery preparation. A high sulfur loading and low electrolyte-to-sulfur (E/S) ratio are key parameters necessary for practical applications.^{[35]} As such, the concentration of the Li₂S₆ solution prepared corresponded to a low E/S ratio of about 5.8, and the amount of Li₂S₆ added corresponded to a high sulfur loading of 3.3 mg cm⁻².

The assembled battery was subsequently evaluated using CV and GC techniques. CV curve showed two sharp reduction peaks and a broad oxidation peak consisting of several overlapping peaks—typical features of a LSB system. The reduction peaks at about 2.3 V and about 2.0 V corresponded to the reduction of elemental S to soluble higher order PS (Li₂Sₓ, 4<x<8), and its further reduction to insoluble Li₂S₂ and Li₂S, respectively, while the broad oxidation peak at about 2.3 to 2.4 V corresponded to the reverse process (see FIG. 5e). A first cycle charge capacity at 0.05° C. was determined to be 1544 mAh g⁻¹, corresponding to an extremely high sulfur utilization of 92%, suggesting excellent sulfur distribution throughout the porous and conductive 3D free-standing carbon scaffold. Subsequent irreversible capacity loss was attributed to polysulfide shuttle. Average discharge capacities at 0.1° C., 0.2° C., 0.5° C. and 1.0° C. were 1208, 1066, 921 and 801 mAh g⁻¹, respectively (see FIG. 60. A high specific discharge capacity of 920 mAh g⁻¹ was obtained after 100 cycles at 0.1° C., and a high CE of >98%, indicating good reversibility and excellent redox kinetics. When sulfur loading was doubled to 6.6 mg cm⁻², a high specific capacity and practical areal capacity of 913 mAh g⁻¹ and 6.1 mAh cm⁻² were obtained, respectively. After 50 cycles, the values dropped to 774 mAh g⁻¹ and 5.1 mAh cm′, respectively (see FIG. 6g). While these results are comparable with other recent work on carbon-based free-standing sulfur electrodes prepared via vacuum filtration, spray pyrolysis or freeze drying, our approach greatly facilitates scale up (see Table 2).

TABLE 2
Electrochemical performance of free-standing sulfur electrodes.

| | | Areal | | | | |
|---|---|---|---|---|---|---|
| Preparation | S | Loading | E/S Ratio | Rate | Specific Discharge | |
| Method | (wt %) | (mg cm⁻²) | (uL mg⁻¹) | (C) | Capacity (mAh g⁻¹) | Reference |
| Vacuum | 54 | 6.3 | ~7.2 | 0.05 | 995 | [S2] |
| Filtration | | | | | | |
| Spray | 66 | 7.1 | 11 | 0.1 | 1268 | [S3] |
| Pyrolysis | | | | | | |
| Freeze | 73 | 4 | 20 | 0.1 | 1212 | [S4] |
| Drying | | | | | | |
| Vacuum | 65 | 10 | 6 | 0.05 | 1131 | [S5] |
| Filtration | | | | | | |
| Slurry Coated | 45 | 3.3 | 5.8 | 0.1 | 1208 | This |
| | | | | | | work |
| Slurry Coated | 64 | 6.6 | 5.8 | 0.05 | 913 | This |
| | | | | | | work |

### Example 7— Preparation of Lithium-Ion Batteries and Lithium Sulfur Batteries

Standard 2032-type coin cells (purchased from Latech Pte. Ltd., Singapore) were used for both cyclic voltammetry and galvanostatic experiments. Battery assembly was carried out in an Ar—filled glovebox, with the 10-mm electrodes as anode/cathode and lithium foil as the anode/reference electrode. 2 pieces of Celgard 2325 (purchased from ANR Technologies Pte. Ltd., Singapore) were wetted with electrolyte, and used as the separators for the LIB electrodes. TiO₂, SnO₂ and LFP electrodes were also wetted with electrolyte and assembled accordingly. For LSB assembly, a separator consisting of a glass fiber membrane (GF/A, GE Healthcare), coated with a thin layer (0.5 mg cm⁻²) of VGCF/PA hydrogel as polysulfide barrier and a Celgard membrane, was wetted with electrolyte. 15 μL and 30 μL of Li₂S₆ solution (E/S=5.8) were dropped between 2 pieces of the carbon scaffold to obtain a sulfur loading of 3.3 and 6.6 mg cm⁻², corresponding to a S loading of ˜32 and ˜64 wt %, respectively. Galvanostatic charge-discharge cycling was conducted with a LAND CT2001 battery tester (Wuhan LAND electronics) at 1.0-3.0 V, 0.005-3.0 V, 2.5-4.25 V and 1.7-2.8 V vs. Li/Li⁺ for TiO₂, SnO₂ anode, LFP cathode and sulfur (polysulfide) cathode, respectively. Representative charge-discharge curves was obtained at the second cycle of the stated current rate. Cyclic voltammograms for all electrodes were obtained at a scan rate of 0.05 mV s⁻¹. M204 Autolab potentiostat (Metrohm).

### INDUSTRIAL APPLICABILITY

The hydrogel binder of the disclosure may be used to prepare free-standing electrodes that eliminate the need for metallic current collectors in lithium batteries.

The free-standing electrode of the disclosure may be used in a variety of applications such as coin cells, pouch batteries, cylindrical batteries, prismatic batteries, energy storage devices, biosensors, implantable electrodes or an electrode in capacitors or organic microelectronics.

The batteries of the disclosure may be used in in electrochromic devices, in sensors for organic and bio-organic materials, in field effect transistors, printing plates, portable electronics, drones, satellites or electric vehicles.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

### REFERENCES

[S1] A. A. AbdelHamid, Y. Yu, J. Yang, J. Y. Ying, Adv. Mater. 2017, 29, 1701427.
[S2] Z. Yuan, H.-J. Peng, J.-Q. Huang, X.-Y. Liu, D.-W. Wang, X.-B. Cheng, Q. Zhang, Adv. Funct. Mater. 2014, 24, 6105-6112.
[S3] R. Ummethala, M. Fritzsche, T. Jaumann, J. Balach, S. Oswald, R. Nowak, N. Sobczak, I. Kaban, M. H. Rummeli, L. Giebeler, Energy Storage Mater. 2018, 10, 206-215.
[S4] J. Zhang, J.-Y. Li, W.-P. Wang, X.-H. Zhang, X.-H. Tan, W.-G. Chu, Y.-G. Guo, Adv. Energy Mater. 2018, 8 1702839.
[S5] S. H. Chung, K. Y. Lai, A. Manthiram, Adv. Mater. 2018, 30, e1805571.

What is claimed is:

1. A hydrogel binder comprising an anionic polyacid, a cationic polyamine and a solvent, wherein the anionic polyacid and the cationic polyamine are derived from an acid-base reaction between a polyacid and a polyamine at a weight ratio in the range of 10:100 to 40:100.

2. The hydrogel binder of claim 1, wherein the weight ratio of the polyacid and the polyamine is 24:100.

3. The hydrogel binder of claim 1, wherein the polyacid is alginic acid or a salt thereof, the polyamine is polyethyleneimine or a salt thereof and the solvent is an aqueous medium.

4. A method of synthesizing a hydrogel binder comprising mixing a polyacid with a polyamine at a weight ratio in the range of 10:100 to 40:100 in a solvent.

5. The method of claim 4, wherein the weight ratio of the polyacid and the polyamine is 24:100.

6. The method of claim 4, wherein the polyacid is alginic acid or a salt thereof, the polyamine is polyethyleneimine or a salt thereof and the solvent is an aqueous medium.

7. A free-standing electrode comprising a hydrogel binder and carbon nanotubes, wherein the hydrogel binder comprises an anionic polyacid and a cationic polyamine, wherein the anionic polyacid and the cationic polyamine are derived from an acid-base reaction between a polyacid and a polyamine at a weight ratio in the range of 10:100 to 40:100.

8. The free-standing electrode of claim 7, wherein the weight ratio of the polyacid and the polyamine is 24:100.

9. The free-standing electrode of claim 7, wherein the polyacid is alginic acid or a salt thereof, and the polyamine is polyethyleneimine or a salt thereof.

10. The free-standing electrode of claim 7, further comprising a conductive additive selected from the group consisting of graphene, graphene oxide, reduced graphene oxide, carbon fiber, carbon black and combinations thereof.

11. The free-standing electrode of claim 7, further comprising an active electrode material selected from the group consisting of transition metal oxides, phosphate salts of lithium and a transition metal, metalloids and combinations thereof.

12. A method of preparing a free-standing electrode comprising the steps of:
a) mixing a hydrogel binder and carbon nanotubes in a mixing solvent to form a slurry, wherein the hydrogel binder comprises an anionic polyacid and a cationic polyamine, and wherein the anionic polyacid and the cationic polyamine are derived from an acid-base reaction between a polyacid and a polyamine in a weight ratio in the range of 10:100 to 40:100 and a solvent; and
b) casting and drying the slurry of step (a) on a substrate to form the free-standing electrode.

13. The method of claim 12, wherein in step (a), the weight ratio of the polyacid and the polyamine is 24:100.

14. The method of claim 12, wherein in step (a), the polyacid is alginic acid or a salt thereof, the polyamine is polyethyleneimine or a salt thereof and the solvent is an aqueous medium.

15. The method of claim 12, wherein in step (a), the mixing solvent is a mixture of N-methyl-2-pyrrolidone and water at a volume ratio of 1:1.

16. The method of claim 12, wherein the mixing step (a) further comprises mixing the slurry with a conductive additive selected from the group consisting of graphene, graphene oxide, reduced graphene oxide, carbon fiber, carbon black and combinations thereof.

17. The method of claim 12, wherein the mixing step (a) further comprises mixing the slurry with an active electrode material selected from the group consisting of transition metal oxides, phosphate salts of lithium and a transition metal, metalloids and combinations thereof.

18. The method of claim 12, wherein the mixing step (a) is undertaken by ball milling and/or stirring.

19. A battery comprising the free-standing electrode of claim 7, a sulfur source, a separator and an electrolyte.

20. A battery comprising at least one free-standing electrode of claim 11, a separator and an electrolyte.
